(19) United States
(12) Patent Application Publication
(10) Pub. No.: US 2026/0179330 A1
(43) Pub. Date: Jun. 25, 2026

(54) APPLICATION PROGRAMMING INTERFACES FOR EXTENDED REALITY

(71) Applicant: Telefonaktiebolaget LM Ericsson (publ), Stockholm (SE)

(72) Inventors: Ali EL ESSAILI, Aachen (DE); Natalya TYUDINA, Aachen (DE)

(73) Assignee: Telefonaktiebolaget LM Ericsson (publ), Stockholm (SE)

(21) Appl. No.: 19/127,853

(22) PCT Filed: Sep. 21, 2023
(86) PCT No.: PCT/EP2023/075990

§ 371 Date: May 7, 2025

Related U.S. Application Data
(60) Provisional application No. 63/423,639, filed on Nov. 8, 2022.

(51) Int. Cl. G06T 19/00; H04L 67/131

(52) U.S. Cl. CPC G06T 19/006; H04L 67/131

(57) ABSTRACT

A method (1000) performed by a user equipment (UE) is provided. The method comprises using (s1002) a first set of Application Programing Interfaces (APIs) transmitting a subscription request for subscribing to a session; as a result of subscribing to the session, using (s1004) the first set of APIs, receiving (i) picture data indicating a plurality of pixel values of pixels and depth data indicating a plurality of depth values associated with the pixels or (ii) virtual point data indicating a plurality of virtual points in a three-dimensional, 3D, space; and using (s1006) a second set of APIs, generating extended reality, XR, scene data based at least on the received picture data or the received virtual point data, wherein (i) the plurality of pixel values and the plurality of depth values or (ii) the plurality of virtual points correspond to a virtual 3D representation of an object or a view in a real-world environment.

### TECHNICAL FIELD

Disclosed are method performed by user equipments (UEs), corresponding UEs, a corresponding computer program, and a corresponding carrier.

### BACKGROUND

Currently, extended reality XR devices (e.g., virtual reality (VR) devices, augmented reality (AR) devices, or mixed reality (MR) devices) are widely used in various fields. For example, in case a presenter of a meeting is remotely located from a group of attendees gathered in a conference room for the meeting, the attendees may wear AR displays via which the attendees can see a three-dimensional (3D) representation of the presenter as if the presenter is in the conference room.

### SUMMARY

Even though XR devices are widely used, currently there is no standardized functional architecture and/or Application programming Interfaces (APIs) for XR devices. Such lack of standardized functional architecture and/or APIs may cause compatibility issues when different XR devices are used together. Also, because there is no standardized functional architecture and/or APIs for XR devices, each XR device needs to be configured differently based on different use-cases. Therefore, there is a need to provide a simple standard functional architecture and/or APIs for XR devices.

Accordingly, in one aspect of the embodiments of this disclosure, there is provided a method performed by a user equipment, UE. The method comprises using a first set of APIs, transmitting a subscription request for subscribing to a session. The method further comprises, as a result of subscribing to the session, using the first set of APIs, receiving (i) picture data indicating a plurality of pixel values of pixels and depth data indicating a plurality of depth values associated with the pixels or (ii) virtual point data indicating a plurality of virtual points (e.g., 3D mesh or point cloud) in a three-dimensional, 3D, space. The method further comprises using a second set of APIs, generating extended reality, XR, scene data based at least on the received picture data or the received virtual point data. (i) The plurality of pixel values and the plurality of depth values or (ii) the plurality of virtual points correspond to a virtual 3D representation of an object or a view in a real-world environment.

In another aspect, there is provided a method performed by a user equipment, UE. The method comprises, using a first set of APIs, transmitting a publication request for publishing video stream data for a first session, wherein the video stream data includes either (i) picture data indicating a plurality of pixel values of pixels and depth data indicating a plurality of depth values associated with the pixels or (ii) virtual point data indicating a plurality of virtual points (e.g., 3D mesh or point cloud) in a 3D space. (i) The plurality of pixel values and the plurality of depth values or (ii) the plurality of virtual points correspond to a virtual 3D representation of an object or a view in a real-world environment (e.g., where the UE is located).

In another aspect, there is provided a computer program comprising instructions which when executed by processing circuitry cause the processing circuitry to perform the method of any one of the embodiments described above.

In another aspect, there is provided a carrier containing the computer program of the embodiments described above, wherein the carrier is one of an electronic signal, an optical signal, a radio signal, and a computer readable storage medium.

In another aspect, there is provided a user equipment, UE. The UE is configured to, using a first set of APIs, transmit a subscription request for subscribing to a session. The UE is further configured to, as a result of subscribing to the session, using the first set of APIs, receive (i) picture data indicating a plurality of pixel values of pixels and depth data indicating a plurality of depth values associated with the pixels or (ii) virtual point data indicating a plurality of virtual points (e.g., 3D mesh or point cloud) in a three-dimensional, 3D, space. The UE is further configured to, using a second set of APIs, generate extended reality, XR, scene data based at least on the received picture data or the received virtual point data. (i) the plurality of pixel values and the plurality of depth values or (ii) the plurality of virtual points correspond to a virtual 3D representation of an object or a view in a real-world environment.

In another aspect, there is provided a user equipment, UE. The UE is configured to, using a first set of APIs, transmit a publication request for publishing video stream data for a first session, wherein the video stream data includes either (i) picture data indicating a plurality of pixel values of pixels and depth data indicating a plurality of depth values associated with the pixels or (ii) virtual point data indicating a plurality of virtual points (e.g., 3D mesh or point cloud) in a 3D space. (i) the plurality of pixel values and the plurality of depth values or (ii) the plurality of virtual points correspond to a virtual 3D representation of an object or a view in a real-world environment (e.g., where the UE is located).

In another aspect, there is provided an apparatus comprising a processing circuitry; and a memory, said memory containing instructions executable by said processing circuitry, whereby the apparatus is operative to perform the method of any one of the embodiments described above.

By providing a simple standard functional architecture and/or APIs for XR devices, embodiments of this disclosure allow different XR devices to be used together without compatibility issues and allow supporting various different use-cases (e.g., supporting AR conferencing, supporting 3D video data communications over Web Real Time Communications (WebRTC), supporting extensions of existing video APIs for immersive communications).

The accompanying drawings, which are incorporated herein and form part of the specification, illustrate various embodiments.

### BRIEF DESCRIPTION OF THE DRAWINGS

FIG. 1A shows an exemplary scenario where embodiments of this disclosure can be used.

FIG. 1B shows an exemplary scenario where embodiments of this disclosure can be used.

FIG. 2A shows an exemplary view of a meeting attendee.

FIG. 2B shows an exemplary view of a meeting attendee.

FIG. 3 shows a functional architecture of an AR device.

FIG. 4 shows a functional architecture and APIs of an AR device.

FIG. 5 shows an architecture for AR based communication.

FIG. 6 shows interactions between APIs of an AR device and external entities.

FIG. 7 shows a process for publishing 3D video data, according to some embodiments.

FIG. 8 shows a process for publishing 3D video data, according to some embodiments.

FIG. 9 shows an overall workflow for rendering an XR scene, according to some embodiments.

FIG. 10 shows a process according to some embodiments.

FIG. 11 shows a process according to some embodiments.

FIG. 12 shows an apparatus according to some embodiments.

### DETAILED DESCRIPTION

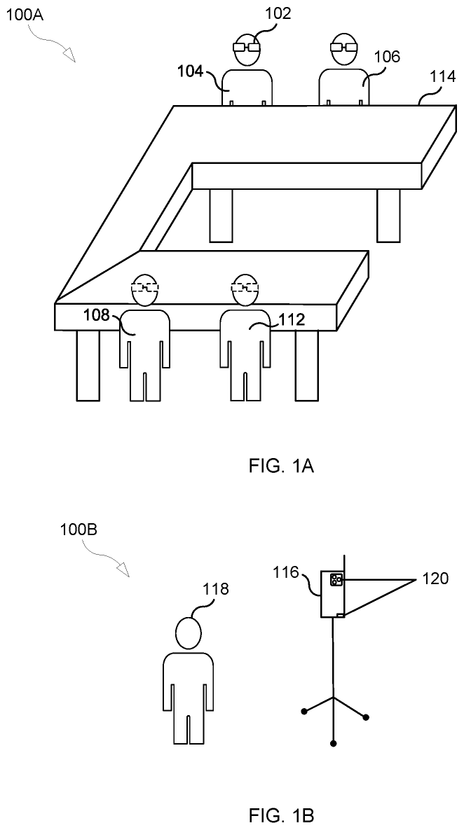

FIGS. 1A and 1B show exemplary scenarios 100A and 100B where embodiments of this disclosure can be used. In scenario 100A, a group of attendees 104, 106, 108, and 112, of a meeting are standing around a desk 114. Each of attendees 104-112 is wearing an XR device 102 (e.g., AR glasses). Note that, for simplification purpose, in the remaining disclosure, the terms “XR” and “AR” will be used interchangeably.

As shown in scenario 100A of FIG. 1A and scenario 100B of FIG. 1B, presenter 118 of the meeting is not in the same space as attendees 104-112. In other words, presenter 118 is remotely located from where the group of attendees 104-112 is located. A view of presenter 118 may be captured by a sensing device 120 included in UE 116, and the captured view of presenter 118 may be transmitted to AR devices 102. Thus, with AR devices 102, attendees 104-112 can see a 3D representation of presenter 118. Sensing device 120 may comprise one or more sensors. For example, sensing device 120 may include RGB sensor(s) capable of generating a plurality of pixel values of pixels and depth sensor(s) (e.g., a 3D camera that is capable of capturing a 3D representation of an object) capable of generating a plurality of depth values associated with the pixels. Additionally, sensing device 120 may also include an audio sensor (e.g., a microphone) capable of capturing audio and generating audio data.

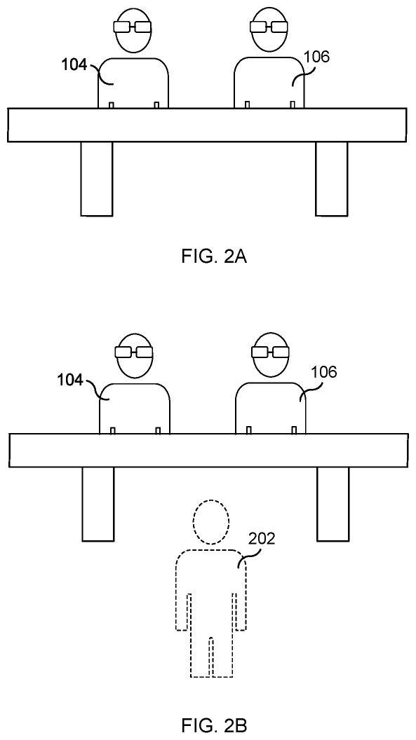

FIG. 2A shows a view of attendee 108 without wearing AR device 102 while FIG. 2B shows a view of attendee 108 via AR display 102. Since presenter 118 is not in the same space as attendee 108, as shown in FIG. 2A, attendee 108 can only see attendees 104 and 106 but not presenter 118. However, with AR device 102, attendee 108 can now see a 3D representation 202 of presenter 118 as well as attendees 104 and 106. More specifically, AR device 102 may obtain the 3D representation of presenter 118 that is captured by sensing device 120, and display the 3D representation of presenter 118 on top of real views of attendees 104 and 106.

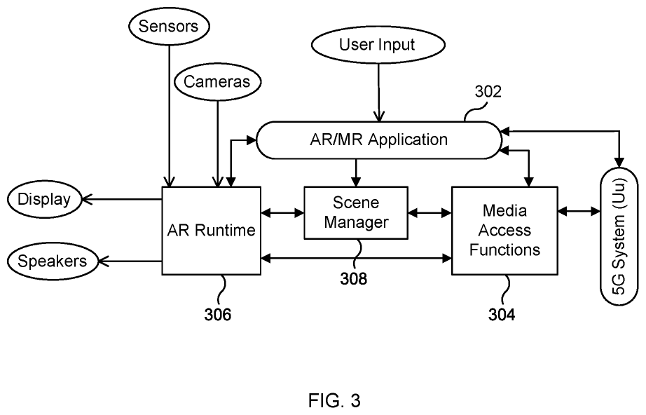

FIG. 3 shows an exemplary functional architecture of AR device 102. The functional architecture shown in FIG. 3 is applicable to any type of AR devices defined by Media Capabilities for Augmented Reality (MeCAR), which are described in S4-221272, MeCAR Permanent Document, v3.1, https://www.3gpp.org/ftp/TSG_SA/WG4_CODEC/TSGS4_121_Toulouse/Docs/S4-221272.zip.

AR device (a.k.a., an AR user equipment (UE)) 102 may include embedded 5G modem and 5G system components, which enable the AR device to transmit and/or receive data via a 5G network. AR device 102 may also include other components such as sensors and user controllers that may be used for providing AR experience. As shown in FIG. 3, examples of those components include camera(s), microphone(s), speaker(s), a display, and a generic user input device (e.g., button(s), touch panel(s), touch display(s), etc.).

As shown in FIG. 3, an AR/MR application 302 may be installed at AR device 102. The application is responsible for orchestrating various device resources to offer AR experience to a user (e.g., 3D representations of attendees 104-112). More specifically, AM/MR application 302 is capable of communicating with the following three main components of XR device 102: Media Access Functions (MAF) module 304, AR runtime module 306, and AR scene manager module 308.

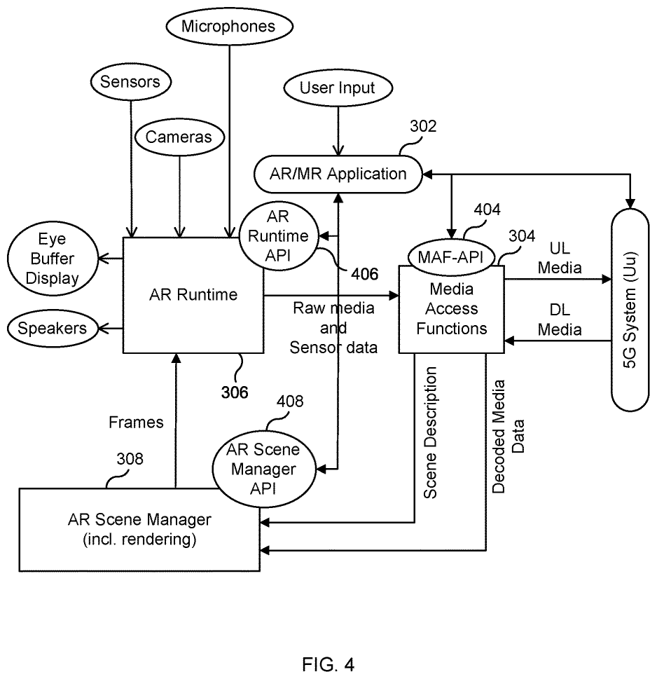

In some embodiments, AR/MR application 302 is configured to communicate with the three components via dedicated APIs called MAF-API 404, AR runtime API 406, and AR scene manager API 408, shown in FIG. 4. Among other functionalities, these APIs enable AR/MR application 302 to discover and query media capabilities (e.g., a resolution of a camera) in terms of support as well as available resources at runtime.

In rendering an AR/MR scene, AR/MR application 302 may obtain from AR runtime module 306 head orientation information indicating the head orientation of a user (e.g., one of attendees 104-112) and provide the obtained head orientation information to AR scene manager module 308.

Based on this information, AR scene manager module 308 may determine the objects that are visible to the user at a given point in time according to the current head orientation or more generally the objects that may be needed to be rendered in the next rendering cycles.

AR scene manager module 308 then provides the rendered views to AR runtime module 306 as frames written to the images of the swapchains, of which formats where configured beforehand by AR/MR application 302 using the information provided by AR runtime API 406. From those images in the swapchains, AR runtime module 306 then generates the left and right eye buffers possibly based on late adjustment techniques using updated head pose information, if available, commonly known as late stage reprojection (LSR).

Once AR/MR application 302 is running, downlink media data may be received from the 5G System to MAF module 304 in compressed form and then transmitted from MAF module 304 to AR scene manager module 308 in a decoded form. In parallel, AR device 102 is capable of establishing an uplink data flow from AR runtime module 306 to MAF module 304 wherein the data may be in an uncompressed form and then from MAF module 304 to the 5G System wherein MAF module 304 may have compressed the data in order to facilitate the expected transmission over the network.

Holographic Communication is one of key use-cases that will enable authentic human communication by extending 2D video calling capabilities to immersive 3D. 3GPP defined AR conferencing use-cases described in 3GPP TR 26.998, Support of 5G glass-type Augmented Reality/Mixed Reality (AR/MR) devices, V17.1, 09/2022, that will support immersive communications (e.g., use-case 19 described in the cited reference).

AR conferencing can be used for education/training/coaching to bring expertise of all kinds into the home, e.g., learn, piano, fitness, makeup, fixing the roof etc., thereby allowing to interact with and see the expert or vice versa (including 3D objects). It can also be used for influencers to bring in influencer to the room and do things together, e.g., e-commerce. AR conferencing can also be used for regular peer-to-peer and multiparty conferencing.

Note that, in this disclosure, AR calling, AR conferencing, and holographic communication are used interchangeably to refer to use 3D media for real-time communication use-cases.

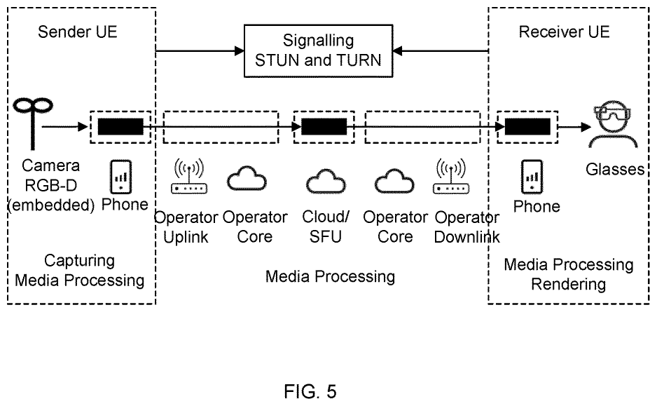

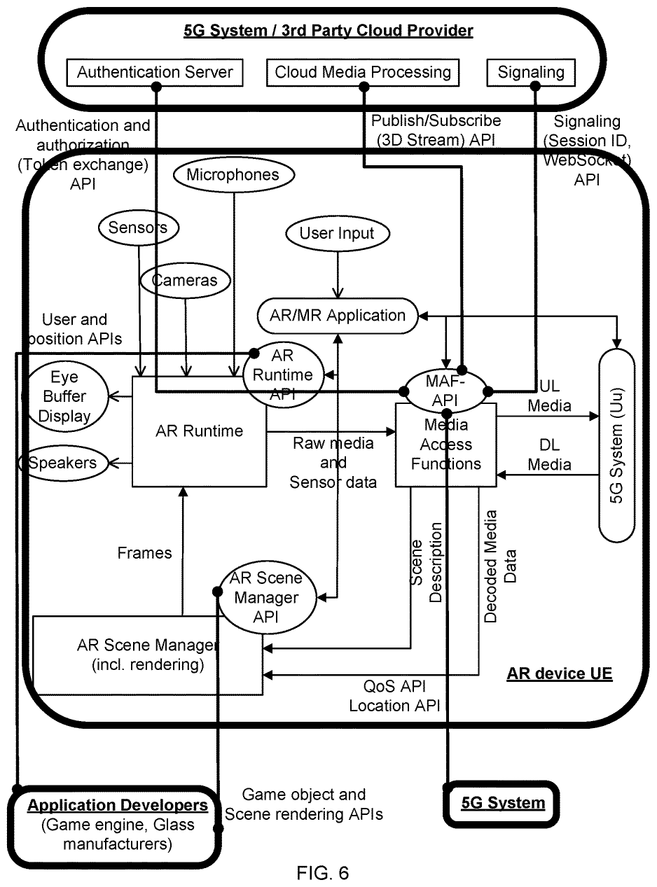

FIG. 5 shows an architecture for AR based communication (e.g., 3D holographic communication). One example of 3D holographic communication is an AR conferencing. More specifically, as shown in scenario 100A and 100B, in case presenter 118 of the meeting is remotely located from attendees 104-112, presenter 118 may be displayed as a holographic image on AR devices 102 that attendees 104-112 are wearing.

For an AR conferencing, a person (e.g., presenter 118) may be captured by a sensing device (e.g., sensing device 120) of a sending UE (i.e., the UE that is configured to send 3D video data) with 3D (depth) video capturing capabilities. For example, the sensor may include one or more RGB sensor(s) generating picture data that indicates a plurality of pixel values of pixels and one or more depth sensors generating depth data that indicates a plurality of depth values. Thus, the sensing device may be configured to capture a 3D representation of the person (e.g., presenter 118).

The picture data and the depth data may be compressed, and one or more data streams corresponding to the compressed picture data and the compressed depth data may be generated and transmitted via a secure Web Real Time Communications (Web-RTC) channel to the cloud.

A cloud media processing unit may process the received data streams, thereby generating a mesh or point cloud representation (e.g., a plurality of virtual point identifying the 3D representation of presenter 118). In case there are multiple device instances, a cloud selective forwarding unit (SFU) may be provided at the cloud for handling communication between the multiple device instances. A receiving UE receives and decodes the data streams, thereby reproducing the 3D representation of the person.

The architecture shown in FIG. 5 is configured to support multiple media streams (e.g., audio stream, RGB data stream, depth data stream) and a 3D representation (e.g., scene object).

The transport of the media streams between the sender UE and the cloud and the transport of the media streams between the receiver UE and the cloud may be performed via WebRTC and/or medial channel. WebRTC signaling and discovery mechanisms may also be used for establishing communication between different peers.

In achieving the AR based communications, APIs (to be used at the sending UEs and/or at the receiving UEs) towards 5G system and 3^{rd} party application providers/developers need to be specified. Thus, according to some embodiments, the following three API sets—MAF-API 404, AR runtime API 406, and AR scene manager API 408—are provided for interaction with 5G system and 3^{rd} party application providers/developers.

### The MAF API Set

The MAF API set interacts with 5G system for Quality of Service (QoS) and connectivity management, device location management, etc. using QoS and location APIs. The MAF API set interacts with 5G system and/or 3^{rd} party cloud providers for signaling, media transport and authentication APIs. How the MAF API set interacts with 5G system and/or 3^{rd} party cloud providers depends on the use-case requirements and business relationship between application provider and 5G system. For instance, media processing can be performed in a public cloud and authentication can be hosted in a 5G system.

The AR run-time and scene rendering APIs are mainly towards developers (e.g., game engine, AR glass manufactures). The AR run-time API set may include user and position APIs. The scene manager API set may include game object and rendering APIs. The APIs may be accessible for application developers (via APIs/SDKs).

The API sets used for generating an AR scene can be summarized as follows:

| | Mapping to use-case | List of APIs/API | Consumer of |
|---|---|---|---|
| API | (AR conferencing) | functions | the API |
| Media Access | APIs for uplink media | API for creating a | Environment can |
| Functions (MAF) | transmission such as | token for authentication | be a browser or a |
| API set | compressed RGB and | between devices | game engine or |
| | depth. | API for creating a | stand-alone app |
| | APIs for downlink | session between device | (Windows, iOS, |
| | media transmission | and cloud | Linux) for sender |
| | such as point cloud, | API for publishing | (camera client). |
| | 3D mesh, RGB-D or | streams (uplink streams) | Environment is |
| | 2D video (split | API for connecting | game engine for |
| | rendering). | to the session - both | receiving data, |
| | | peers (sender and | because at the |
| | | receiver) | moment this is no |
| | | API for subscribing | browser support |
| | | to a session - (downlink | for glasses yet. |
| | | streams) | MAF is tightly |
| | | | coupled with |
| | | | WebRTC |
| | | | libraries/SDKs. |
| AR scene manager | APIs for rendering | API for creating an | Game Engine for |
| API set | of 3D objects. | AR scene | XR glasses or |
| | | API for creating a | native |
| | | game object | development |
| | | API for assigning | environment for |
| | | decoded 3D data to | ARCore/ARKit. |
| | | game object | No browser |
| | | API for rendering | support for AR |
| | | a scene | glasses is |
| | | | available at |
| | | | the moment. |
| | | | However, three.js |
| | | | can create a scene, |
| | | | render objects as |
| | | | well. |
| AR run-time | APIs for positioning | API for rendering | Glasses SDK. In |
| API set | of 3D objects in | (producing) a field of | future, it could be |
| | the scene. | user's view captured by | potentially done |
| | | camera(s) | through game |
| | | API for detecting a | engine only. |
| | | position or a head | |
| | | orientation of user | |

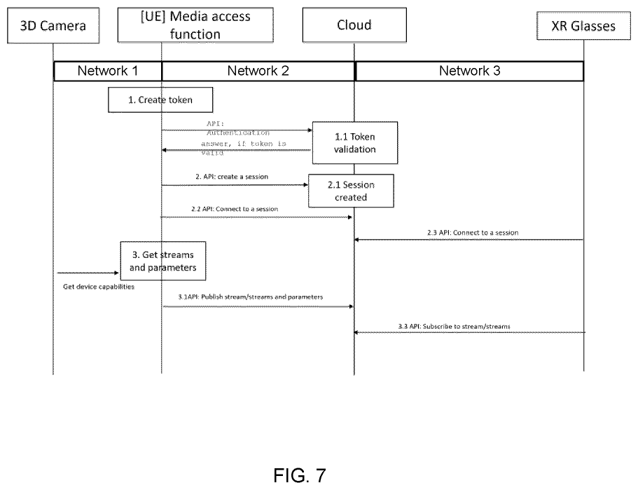

FIG. 7 shows a process performed by the MAF API set for publishing and/or subscribing to 3D video data, according to some embodiments. For example, the process shown in FIG. 7 may be used for AR conferencing in scenarios 100A and 100B. More specifically, the “3D Camera” in FIG. 7 may correspond to sensing device 120, the “Media access function” (MAF) in FIG. 7 may correspond to a function of UE 116, and the “XR Glasses” in FIG. 7 may correspond to AR device 102. Data may be exchanged between the 3D camera and the MAF via network 1, data may be exchanged between the MAF and the cloud via network 2, and data may be exchanged between the cloud and the XR glasses via network 3. Each of networks 1-3 may be any network capable of transmitting and receiving data. The networks 1-3 may be a wired connection such as USB-C connection or a wireless connection (Wifi, Bluetooth of a cellular connection (e.g., 3GPP connections) such as LTE or 5G). In some embodiments, an additional entity (e.g., a mobile phone, a computer, a laptop, a tablet, a server, etc.) may be provided between the cloud and the XR glasses. In such embodiments, the network 3 may be used for exchanging data between the cloud and the additional entity, and a network 4 may be provided for exchanging data between the additional entity and the XG glasses. Like the networks 1-3, the network 4 may be a wired connection such as USB-C connection or a wireless connection (Wifi, Bluetooth of a cellular connection (e.g., 3GPP connections) such as LTE or 5G).

The process may include the following seven steps.

### 1. Create a Token.

In order to authenticate a user attempting to connect to a session, a user's page (e.g., a particular webpage on the user's web browser) may pass a token along with an API key. The token must be generated for each user attempting to connect to a session.

### 2. Create a Session

When a UE (e.g., AR device 102) attempts to connect to a session on an app, a session ID may be used to specify (i.e., identify) the session to connect to. Each session ID identifies a unique session. Conceptually, the session is like a room in which participants meet and chat. This includes a 3D communication session (participants and 3D object sharing).

The number of sessions created and how clients connect to them depend on the requirements of the app. If an app connects users with one another for a one-time meeting, a unique session for that meeting may be created. However, if an app connects users over various days in the same “room,” then one session can be created and be reused. If one group of users meet with each other, while other groups meet independently, unique sessions may be created for each group.

### 2.2. Connect to a Session.

Using a session ID and token, a UE (e.g., AR device 102) can connect to a session. Also, a UE can be disconnected from the sessions. It is also possible to find out when other clients have connected to and disconnected from a session.

### 3.1. Publish Streams

A video (including 3D video) and audio stream in a session that others can view by subscribing to it may be published. Also, stream for 3D objects may also be published.

3.3 Subscribe to a Session from XR Glasses (e.g., 102).

According to some embodiments, the process shown in FIG. 7 can be used for video conferencing. For example, a presenter of a meeting may use a camera to capture the presenter's 3D representation and publish it to other meeting attendees. The meeting attendees may subscribe to the meeting and thus receive video stream data corresponding to the published data (i.e., the presenter's 3D representation). There may be a scenario where, for example, one of the attendees may capture his/her 3D representation using one or more cameras and publish the captured 3D representation, and the presenter who is subscribed to the meeting may receive video stream data corresponding to the captured 3D representation of the attendee. In a summary, in some embodiments, the publication can be performed only at one side and the subscription can be performed only at one side. In other embodiments, the publication can be performed at both sides and the subscription can be performed at both sides.

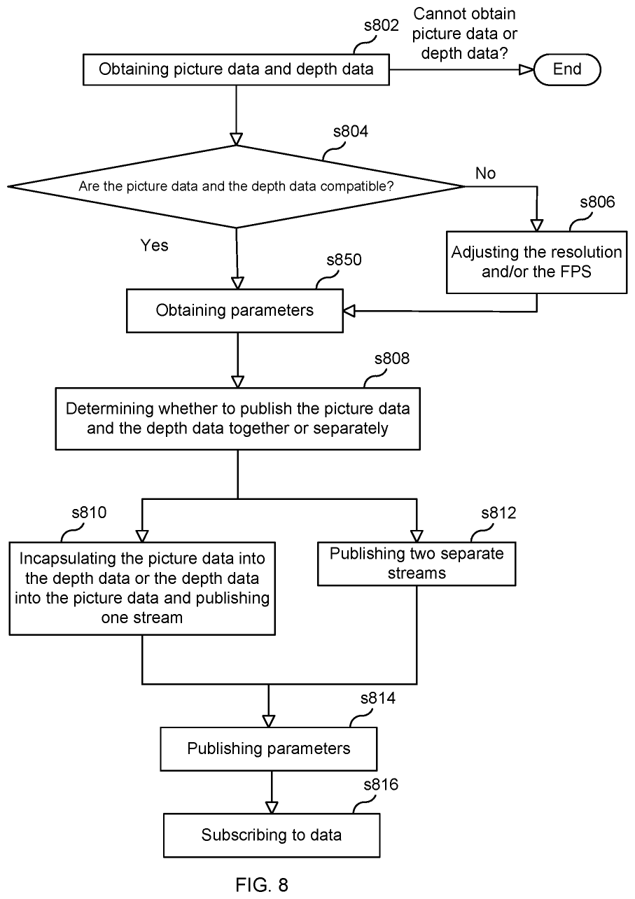

FIG. 8 shows a process 800 for publishing 3D video data (e.g., for holographic communication) and subscribing to a session related to the published 3D video data, according to some embodiments. Process 800 may be performed by the MAF API set included in UE 116.

Process 800 may begin with step s802. Step s802 comprises obtaining picture data and depth data corresponding to a video stream. The picture data may comprise a plurality of values of pixels and the depth data may comprise a plurality of depth values corresponding to the pixels. As shown in FIG. 8, if either the picture data or the depth data cannot be obtained, process 800 ends.

On the other hand, if both data can be obtained, process 800 may proceed to step s804. Step s804 comprises checking compatibility between the picture data and the depth data. For example, the resolution of the picture data corresponding to a picture may be compared to the resolution of the depth data corresponding to a picture. Additionally or alternatively, the frame rate (e.g. frames per second (FPS)) of the picture data may be compared with the frame rate of the depth data.

In case the resolutions of the picture data and the depth data are the same and the FPS of the picture data and the depth data are the same, process 800 may proceed to step s808. On the other hand, in case the resolutions of the picture data and the depth data are different and/or the FPS of the picture data and the depth data are different process 800 may proceed to step s806.

Step 806 comprises adjusting the resolution and/or the frame rate of the picture data and/or the resolution and/or the frame rate of the depth data so that the resolutions of the picture data and the depth data are the same and the FPSs of the picture data and the depth data are the same. There are different ways of adjusting the resolution and the frame rate.

For example, if the frame rate (e.g., 60 FPS) of the picture data is higher than the frame rate (e.g., 30 FPS) of the reference data, the frame rate of the picture data can be lowered such that the adjusted frame rate (e.g., 30 FPS) of the picture data is same as the frame rate of the reference data. In another example, if the resolution of the picture data is higher than the resolution of the reference data, the resolution of the picture data can be lowered such that the adjusted resolution of the picture data is same as the resolution of the reference data.

Once the resolutions of the picture data and the depth data are the same and the FPS of the picture data and the depth data are the same, process 800 may proceed to step s850. Step s850 comprises obtaining parameters that may be needed for converting the picture data and the depth data into a point cloud (i.e., a plurality of virtual points). Examples of these parameters include focal lengths of the lenses used for capturing depth data. After performing step s850, process 800 may proceed to step s808.

Step s808 comprises determining whether to publish the picture data and the depth data separately or together. In some embodiments, this determination may be made based on a user preference.

If it is determined that the picture data and the depth data are to be published separately, process 800 may proceed to step s810. On the other hand, if it is determined that the picture data and the depth data are to be published together, process 800 may proceed to step s812.

Step s810 comprises combining the picture data and the depth data, thereby generating one stream of data. For example, the picture data may be incapsulated into the depth data. In another example, the depth data may be incapsulated into the picture data. The combined picture data and the depth data is published as one stream of data.

Step s812 comprises publishing the picture data as one stream of data and the depth data as another stream of data.

After publishing the picture data and the depth data, process 800 may proceed to step s814. Step s814 comprises publishing the parameters obtained in step s850.

The publishing additionally includes audio stream and can include non-dynamic 3D objects, represented as RGB and depth or 3D mesh/point cloud.

Step s816 compromises subscribing to data and depth data streams, or hologram (3D mesh or point cloud), or a 2D video in case of split rendering (in response to step 0068).

The subscription additionally includes audio stream and can include non-dynamic 3D objects, represented as RGB and depth or as 3D mesh (in response to step 0069).

As discussed above, the scene manger API set is configured to handle rendering a scene, 3D objects, and/or hologram (3D mesh or point cloud). In order to handle the rendering of a scene, the scene manager API may be configured to perform the following steps: (1) creating a game object; (2) assigning decoded 3D data to the created game object; (3) rendering a scene; and (4) rendering the hologram (the 3D representation) in the scene.

As discussed above, the AR run-time API set is configured to handle positioning of 3D objects in a scene and localization of a user. It includes the engine camera video frame and the position of a user. AR run-time APIs can also include user location 6DOF, user location in regards to hologram, number of rendered frames, etc. The APIs can be also packaged via SDKs for application developers.

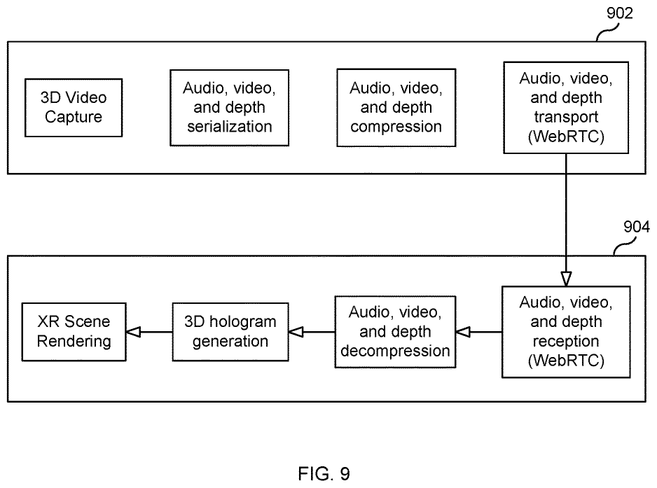

FIG. 9 shows an overall workflow 900 for rendering an XR scene, according to some embodiments. Workflow 900 comprises a first sub-workflow 902 and a second sub-workflow 904. First sub-workflow 902 may be performed by a sending UE (e.g., 120 shown in FIG. 1B) while second sub-flow 904 may be performed by a receiving UE (e.g., 102 shown in FIG. 1A).

In first sub-workflow 902, first, 3D video data is obtained. For example, in scenario 100B, a view of presenter 118 is continuously captured using sensor 120 (which may include camera(s), microphone(s), and/or depth sensor(s)) of UE 116, and 3D video data corresponding to the captured view of presenter 118 is generated. The 3D video data may comprise picture data including a plurality of pixel values of pixels and depth data including a plurality of depth values of the pixels.

In addition to the 3D video data, audio (e.g., voice of presenter 118) may also be captured by sensor 120, and audio data corresponding to the captured audio may also be generated.

The captured picture, depth, and audio data may be serialized, and then compressed, in order to use less bandwidth for transmitting the captured data. The compressed picture, depth, and audio data may be transported using Web Real Time Communication (WebRTC). Note that WebRTC can transport multiple streams.

In some embodiments, in addition to the compressed picture, depth, and audio data, camera intrinsic parameters (e.g., for hologram generation) can be included in headers of the messages used for transporting the compressed picture, depth, and audio data.

In some embodiments, Real Time Protocol (RTP) may be used for transporting the compressed picture, depth, and audio data. In such embodiments, RTP extended headers may be used for carrying information about 3D objects, Session Description Protocol (SDP) information for 3D communication in WebRTC, and or camera intrinsic parameters for hologram creation.

Referring back to FIG. 9, in second sub-workflow 904, first, the compressed picture, depth, and audio data may be received, for example, by UE 102, via WebRTC. The received compressed data may be decompressed, thereby generating reconstructed picture data, reconstructed depth data, and reconstructed audio data.

The reconstructed data may be used for generating a 3D holograph (e.g., image or video 202 of presenter 118), and an XR scene may be generated using the generated 3D hologram. In some embodiments, the 3D holograph and the XR scene are generated in a game engine (e.g., Unity).

Even though the above embodiments are described with respect to the MAF API set, the XR scene manager API set, the XR run-time API set, different API sets may be used for performing the functions of the three API sets.

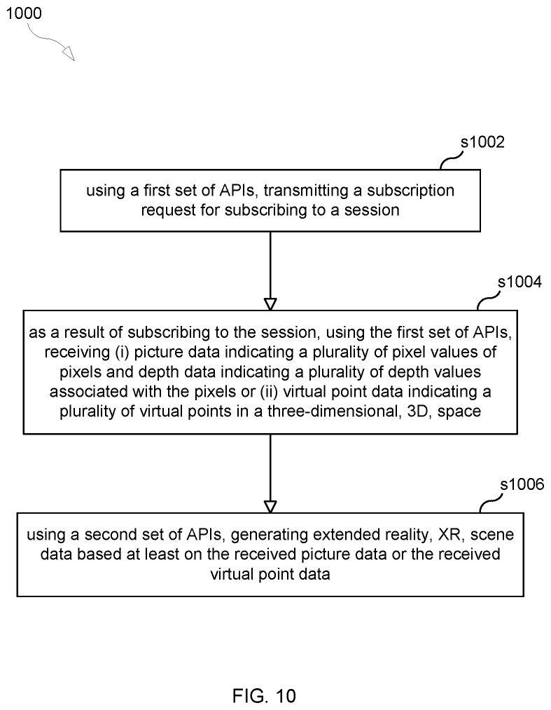

FIG. 10 shows a process 1000 performed by a user equipment (e.g., AR device 102). Process 1000 may begin with step s1002. Step s1002 comprises using a first set of APIs, transmitting a subscription request for subscribing to a session. Step s1004 comprises, as a result of subscribing to the session, using the first set of APIs, receiving (i) picture data indicating a plurality of pixel values of pixels and depth data indicating a plurality of depth values associated with the pixels or (ii) virtual point data indicating a plurality of virtual points (e.g., 3D mesh or point cloud) in a three-dimensional, 3D, space. Step s1006 comprises, using a second set of APIs, generating extended reality, XR, scene data based at least on the received picture data or the received virtual point data. (i) The plurality of pixel values and the plurality of depth values or (ii) the plurality of virtual points correspond to a virtual 3D representation of an object or a view in a real-world environment.

In some embodiments, process 1000 may further comprise: using the first set of APIs, creating a security token for authenticating the UE; using the first set of APIs, transmitting the security token towards a network node; and using the first set of APIs, receiving from the network node a token accept message indicating that the security token has been accepted.

In some embodiments, the session is assigned with a session ID, and the method comprises, using the first set of APIs, transmitting a session connection request for connecting to the session, wherein the session connection request includes the session ID.

In some embodiments, process 1000 may further comprise, using the first set of APIs, transmitting a publication request for publishing video stream data, wherein the video stream data includes another picture data indicating a plurality of pixel values and depth data indicating a plurality of depth values associated with the pixel values.

In some embodiments, the plurality of pixel values and the plurality of depth values of said another picture data correspond to a virtual 3D representation of an object or a view in a real-world environment where the UE is located.

In some embodiments, process 1000 may further comprise obtaining video stream data, wherein the video stream data includes another picture data indicating a plurality of pixel values of pixels and depth data indicating a plurality of depth values associated with the pixels; converting the video stream data into another virtual point data indicating a plurality of virtual points (e.g., 3D mesh or point cloud) in a 3D space; and using the first set of APIs, transmitting a publication request for publishing said another virtual point data.

In some embodiments, the plurality of virtual points indicated by said another virtual point data correspond to a virtual 3D representation of an object and/or a view in a real-world environment where the UE is located.

In some embodiments, process 1000 may further comprise: using a third set of APIs, capturing, with one or more cameras, a 3D representation of an object and/or a view of a real-world environment in which the UE is located; and generating real-world data indicating the captured view of the real-world environment; and using the third set of APIs, combining the point data and the real-world data, thereby generating the XR scene data.

In some embodiments, process 1000 may further comprise: using the third set of APIs, detecting a head orientation of a user, wherein the view of the real-world environment is captured in accordance with the detected head orientation of the user.

In some embodiments, the generated XR scene data is used for AR conference.

In some embodiments, the first set of APIs is media access functions, MAF, application programming interface, API set.

In some embodiments, the second set of APIs is an XR scene manager API set.

In some embodiments, the third set of APIs is an XR run-time API set.

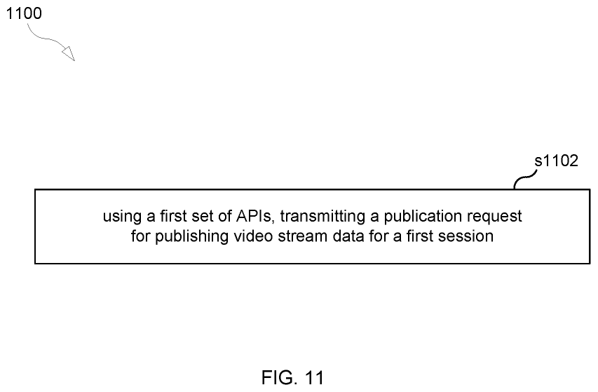

FIG. 11 shows a process 1100 performed by a user equipment (e.g., AR device 102). Process 1000 comprises step s1102. Step s1102 comprises, using a first set of APIs, transmitting a publication request for publishing video stream data for a first session, wherein the video stream data includes either (i) picture data indicating a plurality of pixel values of pixels and depth data indicating a plurality of depth values associated with the pixels or (ii) virtual point data indicating a plurality of virtual points (e.g., 3D mesh or point cloud) in a 3D space. (i) the plurality of pixel values and the plurality of depth values or (ii) the plurality of virtual points correspond to a virtual 3D representation of an object or a view in a real-world environment (e.g., where the UE is located).

In some embodiments, process 1100 further comprises using the first set of APIs, transmitting a subscription request for subscribing to a second session; as a result of subscribing to the session, using the first set of APIs, receiving (i) another picture data indicating a plurality of pixel values of pixels and depth data indicating a plurality of depth values associated with the pixels or (ii) another virtual point data indicating a plurality of virtual points (e.g., 3D mesh or point cloud) in a three-dimensional, 3D, space; and using a second set of APIs, generating extended reality, XR, scene data based at least on the received picture data or the received virtual point data.

In some embodiments, process 1100 further comprises: using the first set of APIs, creating a security token for authenticating the UE; using the first set of APIs, transmitting the security token towards a network node; and using the first set of APIs, receiving from the network node a token accept message indicating that the security token has been accepted.

In some embodiments, the second session is assigned with a session ID, and the method comprises, using the first set of APIs, transmitting a session connection request for connecting to the second session, wherein the session connection request includes the session ID.

In some embodiments, process 1100 comprises: using a third set of APIs, capturing, with one or more cameras, a 3D representation of an object and/or a view of a real-world environment in which the UE is located; generating real-world data indicating the captured view of the real-world environment; and using the third set of APIs, combining the point data and the real-world data, thereby generating the XR scene data.

In some embodiments, process 1100 comprises, using the third set of APIs, detecting a head orientation of a user, wherein the view of the real-world environment is captured in accordance with the detected head orientation of the user.

In some embodiments, the generated XR scene data is used for AR conference.

In some embodiments, the first set of APIs is media access functions, MAF, application programming interface, API set.

In some embodiments, the second set of APIs is an XR scene manager API set.

In some embodiments, the third set of APIs is an XR run-time API set.

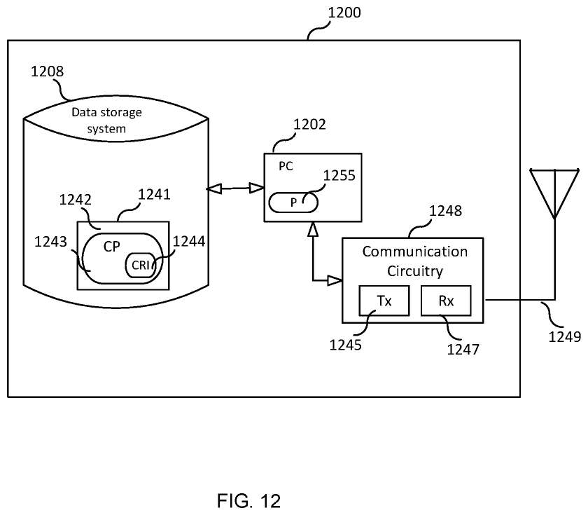

FIG. 12 is a block diagram of UE 102, according to some embodiments. As shown in FIG. 12, UE 102 may comprise: processing circuitry (PC) 1202, which may include one or more processors (P) 1255 (e.g., one or more general purpose microprocessors and/or one or more other processors, such as an application specific integrated circuit (ASIC), field-programmable gate arrays (FPGAs), and the like); communication circuitry 1248, which is coupled to an antenna arrangement 1249 comprising one or more antennas and which comprises a transmitter (Tx) 1245 and a receiver (Rx) 1247 for enabling UE 102 to transmit data and receive data (e.g., wirelessly transmit/receive data); and a local storage unit (a.k.a., “data storage system”) 1208, which may include one or more non-volatile storage devices and/or one or more volatile storage devices. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes UE 102 to perform steps described herein (e.g., steps described herein with reference to the flow charts). In other embodiments, UE 102 may be configured to perform steps described herein without the need for code. That is, for example, PC 1202 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a user equipment (UE), the method comprising:
using a first set of Application Programing Interfaces (APIs), transmitting a subscription request for subscribing to a session;
as a result of subscribing to the session, using the first set of APIs, receiving (i) picture data indicating a plurality of pixel values of pixels and depth data indicating a plurality of depth values associated with the pixels or (ii) virtual point data indicating a plurality of virtual points in a three-dimensional (3D) space; and
using a second set of APIs, generating extended reality (XR) scene data based at least on the received picture data or the received virtual point data, wherein
(i) the plurality of pixel values and the plurality of depth values, or
(ii) the plurality of virtual points correspond to a virtual 3D representation of an object or a view in a real-world environment.

2. The method of claim 1, wherein the method further comprises:
using the first set of APIs, creating a security token for authenticating the UE;
using the first set of APIs, transmitting the security token towards a network node; and
using the first set of APIs, receiving from the network node a token accept message indicating that the security token has been accepted.

3. The method of claim 1, wherein
the session is assigned with a session ID, and
the method further comprises, using the first set of APIs, transmitting a session connection request for connecting to the session, wherein the session connection request includes the session ID.

4. The method of claim 1, further comprising:
using the first set of APIs, transmitting a publication request for publishing video stream data, wherein the video stream data includes another picture data indicating a plurality of pixel values and depth data indicating a plurality of depth values associated with the pixel values.

5. (canceled)

6. The method of claim 1, further comprising:
obtaining video stream data, wherein the video stream data includes another picture data indicating a plurality of pixel values of pixels and depth data indicating a plurality of depth values associated with the pixels;
converting the video stream data into another virtual point data indicating a plurality of virtual points in a 3D space; and
using the first set of APIs, transmitting a publication request for publishing said another virtual point data.

7. (canceled)

8. The method of claim 1, further comprising:
using a third set of APIs, capturing, with one or more cameras, a 3D representation of an object and/or a view of a real-world environment in which the UE is located;
generating real-world data indicating the captured view of the real-world environment; and
using the third set of APIs, combining the point data and the real-world data, thereby generating the XR scene data.

9-13. (canceled)

14. A method performed by a user equipment (UE), the method comprising:
using a first set of Application Programming Interfaces (APIs), transmitting a publication request for publishing video stream data for a first session, wherein the video stream data includes either (i) picture data indicating a plurality of pixel values of pixels and depth data indicating a plurality of depth values associated with the pixels or (ii) virtual point data indicating a plurality of virtual points in a three-dimensional (3D) space, wherein
(i) the plurality of pixel values and the plurality of depth values, or
(ii) the plurality of virtual points correspond to a virtual 3D representation of an object or a view in a real-world environment.

15. The method of claim 14, further comprising:
using the first set of APIs, transmitting a subscription request for subscribing to a second session;
as a result of subscribing to the session, using the first set of APIs, receiving (i) another picture data indicating a plurality of pixel values of pixels and depth data indicating a plurality of depth values associated with the pixels or (ii) another virtual point data indicating a plurality of virtual points in a 3D space; and
using a second set of APIs, generating extended reality (XR) scene data based at least on the received picture data or the received virtual point data.

16. The method of claim 14, further comprising:
using the first set of APIs, creating a security token for authenticating the UE;
using the first set of APIs, transmitting the security token towards a network node; and
using the first set of APIs, receiving from the network node a token accept message indicating that the security token has been accepted.

17. The method of claim 14, wherein
the second session is assigned with a session ID, and
the method further comprises, using the first set of APIs, transmitting a session connection request for connecting to the second session, wherein the session connection request includes the session ID.

18. The method of claim 15, further comprising:
using a third set of APIs, capturing, with one or more cameras, a 3D representation of an object and/or a view of a real-world environment in which the UE is located; and
generating real-world data indicating the captured view of the real-world environment; and
using the third set of APIs, combining the point data and the real-world data, thereby generating the XR scene data.

19-25. (canceled)

26. A user equipment (UE), the UE comprising:
a transmitter;
a receiver;
memory; and
processing circuitry, wherein the UE is configured to perform a method comprising:
using a first set of Application Programing interfaces, APIs employ the transmitter to transmit a subscription request for subscribing to a session;
as a result of subscribing to the session, using the first set of APIs, to receive (i) picture data indicating a plurality of pixel values of pixels and depth data indicating a plurality of depth values associated with the pixels or (ii) virtual point data indicating a plurality of virtual points in a three-dimensional (3D) space; and
using a second set of APIs generating extended reality (XR) scene data based at least on the received picture data or the received virtual point data, wherein
(i) the plurality of pixel values and the plurality of depth values, or
(ii) the plurality of virtual points correspond to a virtual 3D representation of an object or a view in a real-world environment.

27. The UE of claim 26, wherein the method further comprises:
using the first set of APIs, creating a security token for authenticating the UE;
using the first set of APIs, transmitting the security token towards a network node; and
using the first set of APIs, receiving from the network node a token accept message indicating that the security token has been accepted.

28. A user equipment (UE), the UE comprising:
a transmitter;
a receiver;
memory; and
processing circuitry, wherein the UE is configured to perform a method comprising:
using a first set of APIs, employing the transmitter to transmit a publication request for publishing video stream data for a first session, wherein the video stream data includes either (i) picture data indicating a plurality of pixel values of pixels and depth data indicating a plurality of depth values associated with the pixels or (ii) virtual point data indicating a plurality of virtual points in a 3D space, wherein
(i) the plurality of pixel values and the plurality of depth values, or
(ii) the plurality of virtual points correspond to a virtual 3D representation of an object or a view in a real-world environment.

29. The UE of claim 28, wherein the method further comprises:
using the first set of APIs, employing the transmitter to transmit a subscription request for subscribing to a second session;
as a result of subscribing to the session, using the first set of APIs, receiving (i) another picture data indicating a plurality of pixel values of pixels and depth data indicating a plurality of depth values associated with the pixels or (ii) another virtual point data indicating a plurality of virtual points in a 3D space; and
using a second set of APIs, generating extended reality (XR) scene data based at least on the received picture data or the received virtual point data.

30. (canceled)
